(19) United States
(12) Patent Application Publication
(10) Pub. No.: US 2009/0039621 A1
(43) Pub. Date: Feb. 12, 2009

(54) FOLDABLE COMPACT CARRY-ALL

(76) Inventor: Marjorie Parmenter, St. Paul, MN (US)

Correspondence Address: OPPENHEIMER WOLFF & DONNELLY LLP, 45 SOUTH SEVENTH STREET, SUITE 3300, MINNEAPOLIS, MN, 55402, US

(21) Appl. No.: 12/186,586

(22) Filed: Aug. 6, 2008

Related U.S. Application Data
(60) Provisional application No. 60/954,098, filed on Aug. 6, 2007.

(51) Int. Cl. B62B 1/12; B62B 1/00; B62B 5/00

(52) U.S. Cl. 280/654; 280/47.26

(57) ABSTRACT

A collapsible cart comprises a base having a pair of base sections separated by a base joint, a first side having a pair of first side sections separated by a first collapsing means, a second side having a pair of second side sections separated by a second collapsing means, two or more wheels coupled to the base, and storage means coupled to the first and second sides of the cart. The base joint is structured for allowing the base to be moved between an expanded base position and a collapsed base position. Similarly, the first collapsing means is structured for allowing the first side to move between an expanded first side position and a collapsed first side position, while the second collapsing means is structured for allowing the second side to move between an expanded second side position and a collapsed second side position.

### CROSS-REFERENCE TO RELATED APPLICATIONS

This application claims the benefit of Provisional Application Ser. No. 60/954,098, filed on Aug. 6, 2007, the entirety of which is hereby incorporated by reference.

### BACKGROUND OF THE INVENTION

This invention relates generally to the class of two-wheeled carts for transporting one or more items. More particularly, the invention relates to foldable and/or collapsible carts of a compact design that enables the carts to be easily transported and stored when not in use.

For example, many people (especially in colder climates) are resigned to carrying their coats while shopping or traveling, thereby limiting the use of their hands and reducing the amount of items they can hold. Although many stores and airports now offer carts, strollers, or lockers for rental within their establishment, these conveniences are usually restricted for use only in the buildings where they are located. Children's strollers seem awkward when one doesn't have a child in tow, and concerns over germs are ever present. Lockers, if available, are only convenient when you're planning to return to the location where the locker is rented.

Although there are many two-wheeled collapsible carts currently available, the size, weight, and overall bulkiness of these carts make them inconvenient and impractical for most everyday uses. For example, these carts are too large to fit in a purse or handbag, and too awkward to easily carry by hand. Furthermore, the added weight and bulk of the carts is a deterrent as most people attempt to minimize the amount of items they must carry around, especially when they are walking long distances. As a result, these carts are seldom used by individuals who would otherwise greatly benefit from them.

Thus, there exists a need for an improved compact carrying device that is convenient to transport and store when not in use, but that also provides a useful amount of storage capacity in a design that is easy to set-up and maneuver.

### BRIEF SUMMARY OF THE INVENTION

The foldable/collapsible cart of the present invention may be designed to carry a variety of items and fills a rather large niche in today's retail and travel environment. The frame of the cart is presented herein in two exemplary embodiments, although numerous other embodiments are also contemplated and within the intended scope of the present invention.

In a first embodiment, the collapsible cart includes a triangular frame assembly, a pair of wheels, and storage means coupled to the triangular frame assembly. The triangular frame assembly includes a base having a pair of base sections separated by a base joint, a first side having a pair of first side sections separated by a first side joint, and a second side having a pair of second side sections separated by a second side joint. The base joint is structured for allowing the base to be moved between an expanded base position and a collapsed base position. Similarly, the first side joint is structured for allowing the first side to be moved between an expanded first side position and a collapsed first side position, while the second side joint is structured for allowing the second side to be moved between an expanded second side position and a collapsed second side position.

In a second embodiment, the collapsible cart includes a triangular frame assembly, a pair of wheels, and storage means coupled to the triangular frame assembly. The triangular frame assembly includes a base having first and second base sections separated by a base joint, a first side having first and second side sections, and a second side having first and second side sections. The first and second base sections are rotatable about the base joint to collapse the base. The first side section of the first side is slidable within the second side section of the first side to collapse the first side, while the first side section of the second side is slidable within the second side section of the second side to collapse the second side.

### BRIEF DESCRIPTION OF THE DRAWINGS

FIG. 1A is a front view of one exemplary cart with a folding frame in accordance with the present invention.

FIG. 1B is a side view of the cart of FIG. 1A.

FIGS. 2A-2F illustrate an exemplary step-by-step process of collapsing the cart of FIGS. 1A and 1B.

FIG. 3 illustrates an alternative embodiment of a cart with a telescoping fame in accordance with the present invention.

FIGS. 4A-4B illustrate an exemplary step-by-step process of collapsing the cart of FIG. 3.

FIGS. 5A-5B illustrate one exemplary locking mechanism that may be incorporated into the cart of FIG. 3.

FIG. 6 is a diagram illustrating the cart of FIG. 3 being pulled by a user.

### DETAILED DESCRIPTION OF THE INVENTION

Generally speaking, the collapsible cart of the present invention provides a compact, lightweight, and convenient device for users to transport a variety of items. In particular, the collapsible cart of the present invention provides an alternative method of transporting items such that the user is not required to carry the items in their hands. Thus, the collapsible cart of the present invention fills a rather large niche in today's retail and travel environment.

As will be discussed in further detail to follow, the frame of the collapsible cart of the present invention is presented in two exemplary embodiments. Those skilled in the art will appreciate that these two embodiments are illustrated merely for purposes of example and not limitation. Thus, the technical disclosure presented herein may be extended to numerous other variations and embodiments without departing from the intended scope of the present invention.

The first exemplary embodiment includes a folding, triangular frame that collapses in the middle of a base of the triangular frame. The sides of the triangular frame may be designed to pivot together and subsequently fold into several sections. The second exemplary embodiment includes a telescoping, triangular frame that also collapses in the middle of a base of the triangular frame. The sides of the triangular frame are designed to collapse in a telescopic fashion, preferably once a base joint has been released and the two sides have pivoted together. Both frame options result in a compact cart that reduces in size to about 12 inches in length or less, although larger sizes are also contemplated. Both frame options may also include a locking joint at the base of the triangular frame that may utilize a push-button or similar device to release the frame's otherwise rigid form for purposes of collapsing the cart. The sides in both frame embodiments may be designed to softly lock into place requiring only slight pressure from the user to release the frames structure for folding/collapsing purposes. Alternatively, the user may be required to actuate a push-button or suitable release mechanism in order to fold or collapse the sides of the frame. A handle of the cart may be specifically sectioned to accommodate height variation in users and to provide a quick manner in which to secure the cart once it has been collapsed. However, numerous handle designs are contemplated so as to provide flexibility in the function and design of the handle to best complement the style of the cart.

One exemplary use of this invention is for transportation of light-weight, unbreakable, bulky items. Unlike other wheeled carriers or carts that are designed to hold heavy items, such as groceries, golf clubs, gardening supplies, and the like, the carrier of the present invention may be designed specifically but not exclusively for use in shopping malls and airports where people tend to carry coats and/or bags of clothing. For example, carts in accordance with the present invention may be designed to withstand a load of about 20 pounds. However, those skilled in the art will appreciate that the carts may be designed to withstand a greater or smaller load depending upon, for example, the materials used.

One advantage of the present invention is that it may offer a germ-free alternative when shopping or traveling. The unique design allows for manufacturing of the product in a variety of materials, such as any suitable plastic or metal. Exemplary metals may include, but are not limited to, aluminum, titanium, or carbon fiber. Exemplary plastics may include, but are not limited to, thermoplastics that may be reinforced with a fiber or mineral material. Thus, depending on the materials selected, it is possible to create a disposable or low-cost item that may be sold, for example, in vending machines and store checkouts. Alternatively, when more durable materials are used, the carrier may be sold as “fine” luggage with a longer life expectancy.

Although there are many two-wheeled collapsible carts currently available, an advantage of the carrier of the present invention that makes it unique is its size and its weight. In one exemplary embodiment, the carrier may be collapsed down to the size of a typical travel umbrella, with a weight generally less than a few pounds. Designed to be manually pulled behind or pushed by the user, this cart may be small enough to fit down the aisle of most commercial airplanes even when fully expanded. And, because it may be partially folded while still holding items therein, it may easily be placed in overhead compartments or the trunk of a car without first having to remove the contents.

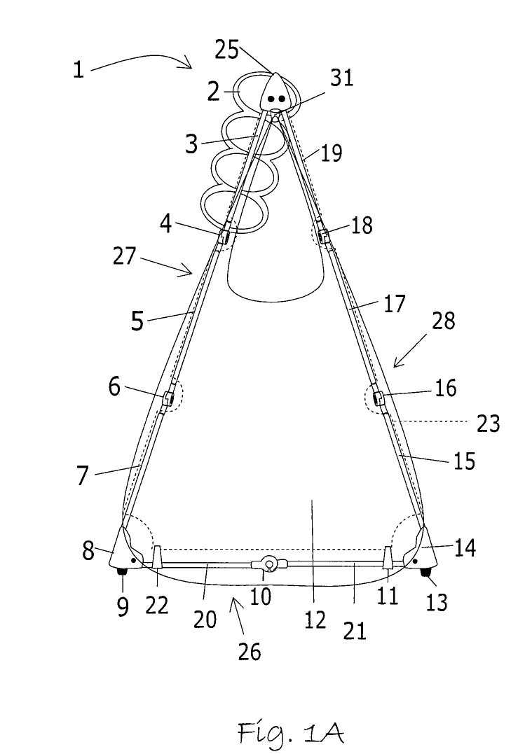

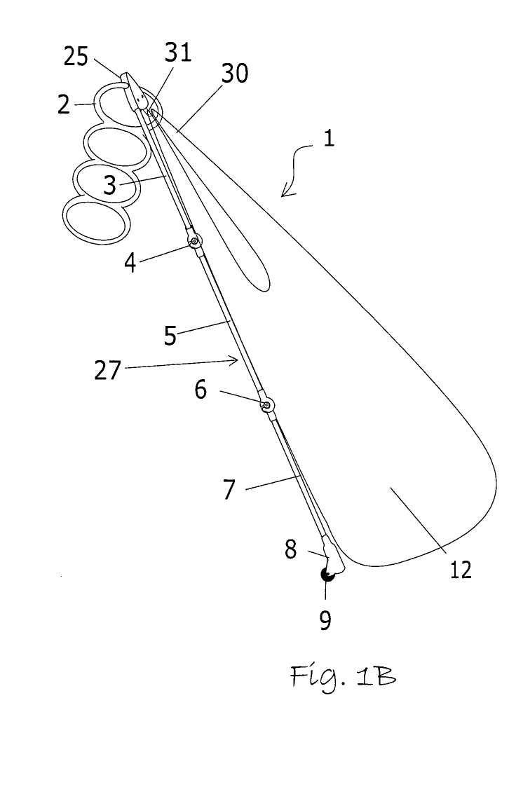

FIGS. 1A and 1B illustrate front and side views, respectively, of one exemplary embodiment of a collapsible cart in accordance with the present invention. In particular, cart 1 includes a folding triangular frame having base 26, first side 27, and second side 28. Cart 1 also includes base joint 10, side joints 4, 6, 16, and 18, handle 2, and cap 25. First side 27 includes first side sections 3, 5 and 7, while second side 28 includes second side sections 15, 17 and 19. Base 26 includes base sections 20 and 21.

In one exemplary embodiment, the height of cart 1 may be about 36 inches, and the width of cart 1 along base 26 may be about 18 inches. However, cart embodiments having a height or width other than about 36 inches and about 18 inches, respectively, are also contemplated.

Base joint 10 of the triangular frame is structured to lock the horizontal base 26 of the frame into place, while side joints 4, 6, 16, and 18 along first and second sides 27 and 28 are structured to lock first and second sides 27 and 28 into place. In one exemplary embodiment, and as illustrated in FIG. 1A, joints 4, 6, 16, and 18 may be “soft locking,” meaning they click into place but may be collapsed or released with a simple downward pressure on either side of the joint. In another exemplary embodiment, side joints 4, 6, 16, and 18 may include any suitable release mechanism, such as a push-button, that may be actuated in order to release the joints from a locked position to an unlocked position. Similarly, base joint 10 may be soft locking or may include any suitable release mechanism in order to release the joint so that base 26 may be folded.

Cap 25 at the top of cart 1 may attach on a top portion to handle 2 and on a bottom portion to side sections 3 and 19 of first and second sides 27 and 28, respectively. Side sections 3 and 19 may be attached to cap 25 in such a way that enables side sections 3 and 19 to pivot within cap 25 to allow for the expansion of the frame. In one exemplary embodiment, side sections 3 and 19 may be coupled to cap 25 with a pin-type connection allowing the sections to pivot relative to cap 25.

Handle 2 may be segmented into soft, flexible sections designed to fit comfortably in a user's hand, and may also serve as a restraint once cart 1 is collapsed. In one exemplary embodiment, handle 2 may be formed from woven polyester cord or a soft pliable plastic. However, those skilled in the art will appreciate that numerous other materials may be used without departing from the intended scope of the present invention. Furthermore, although handle 2 is illustrated as including a plurality of generally circular or ring-shaped segments, handle embodiments having only a single segment or having segments formed as other shapes and sizes are contemplated and within the intended scope of the present invention.

Each of soft locking side joints 4, 6, 16, and 18 maintain their rigidity by structuring the two sides of the joint to fit together in such a way that they may only be turned to a maximum of 180 degrees. The side sections 3, 5, and 7 may be manufactured to attach to side joints 4 and 6 with any suitable connection means, such as a “snap-fit” type connection, or the side sections may be attached to the joints with any suitable fastener or adhesive. Alternatively, side joints 4 and 6 may be manufactured as extensions of the side joints. Side sections 15, 17, and 19 and side joints 16 and 18 may be manufactured in a similar manner.

As illustrated in FIG. 1A, cart 1 may further include a first wheel boot 8 disposed at a first end of base 26 and a second wheel boot 14 disposed at a second end of base 26. In particular, wheel boot 8 may be designed to receive side section 7 of first side 27 and be pivotally connectable to base section 20 of base 26 to allow base section 20 to pivot upward when locking joint 10 is released. Similarly, wheel boot 14 may be designed to receive side section 15 of second side 28 and be pivotally connectable to base section 21 to allow base section 21 to pivot upward when locking joint 10 is released. Alternatively, side sections 7 and 15 may be formed integral with wheel boots 8 and 14, respectively, since movement between these side sections and the wheel boots is not necessary.

Wheel boots 8 and 14 may include wheels 9 and 13, respectively, to enable a user to pull or push cart 1. The wheels may be attached to the wheel boots in any suitable fashion as will be appreciated by those skilled in the art including, for example, with a simple axle. As will further be appreciated by those skilled in the art, any suitable wheel may be used including, but not limited to, those typically found on inline skates or pull-behind pieces of luggage. Such wheels may, for example, have a diameter of about 2 inches. However, as will be appreciated by those skilled in the art, larger wheels are also contemplated for use on large embodiments of the cart. For example, these larger wheels may be inflatable rubber wheels disposed around a metal or plastic rim having a plurality of spokes.

Base sections 20 and 21 may be structured to attach to locking joint 10 with any suitable connection means, such as a snap-fit type connection, or the base sections may be attached to the locking joint with any suitable fastener or adhesive. Alternatively, base sections 20 and 21 may be manufactured as extensions of locking joint 10.

As illustrated in FIG. 1A, locking joint 10 is a push-button type locking joint and requires the user to hold/press a button to release the joint from its fully extended position shown in FIG. 1A. Locking joints 10, 4, 6, 16, and 18 are described as soft locking or push-button type joints throughout this disclosure merely for purposes of example and not for limitation. Thus, other suitable joints may be used as would be appreciated by one skilled in the art. The type of joint used in cart 1 may be determined in part by, for example, the type of materials used to manufacture the cart.

As illustrated in FIG. 1A, cart 1 may include a back panel 23 that fits around first and second sides 27 and 28 and attaches to base 26 to keep back panel 23 and bag 12 from riding up the frame while in use. Back panel 23 is shown in broken lines in FIG. 1A so that the other components of the cart remain visible. Back panel 23 may attach to base 26 with any suitable attachment means, such as with straps or loops 11 and 22. The combination of bag 12 and back panel 23 may be manufactured as two separate pieces attached along base 26 and first and second sides 27 and 28, or alternatively, the combination may be manufactured as a single, integrated unit. Either way, the top of bag 12 is preferably open and may be secured by connecting a top bag portion 30 to an attachment means 31 on cap 25. Attachment means may include any suitable device such as, for example, a hook member.

Bag 12 is attachable to the triangular frame of cart 1 and may be designed to expand forward and to the sides of the center of the frame. In particular, bag 12 may preferably be positioned on the frame so as to allow the user to rest the cart on the bottom of the bag when in use, thereby eliminating the need for a separate foldout stand or leg. Bag 12 may be formed from numerous materials including, but not limited to, a mesh-type material, cloth, nylon, or “cargo” netting. Furthermore, back panel 23 may be formed from any suitable material. In one embodiment, back panel 23 may be formed from a nylon fabric, such as a lightweight “ripstop” material.

The height of the bag may be about the same as the height of the fame formed by base 26, first side 27, and second side 28. In one exemplary embodiment, the height of bag 12 may be about 36 inches, the width of bag 12 along base 26 may be about 18 inches, and the depth of bag 12 may be about 8 inches. However, those skilled in the art will appreciate that these dimensions are only exemplary and may vary depending upon, for example, the dimensions of the cart.

As illustrated in FIGS. 1A and 1B, the exemplary embodiment of cart 1 includes three first side sections 3, 5, and 7, three second side sections 15, 17, and 19, and two base sections 20 and 21. However, cart embodiments having any number of first side, second side, and base sections greater than or equal to two are contemplated and within the intended scope of the present invention. Thus, for example, one alternative embodiment of cart 1 may include two first side sections, two second side sections, and two base sections. As those skilled in the art will appreciate, the number of joints increases when the number of side sections increases.

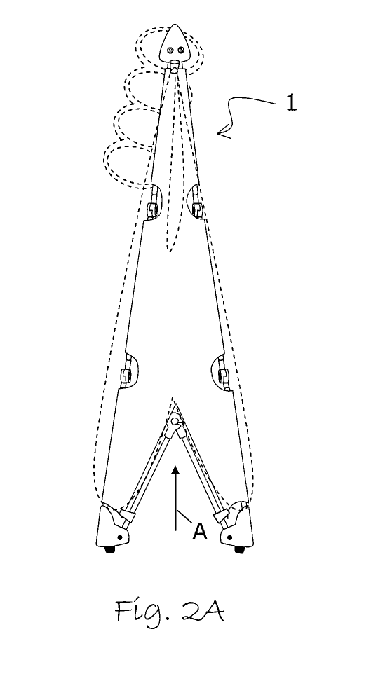

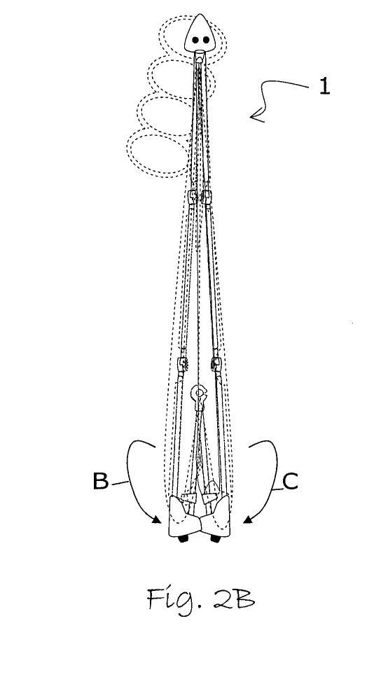

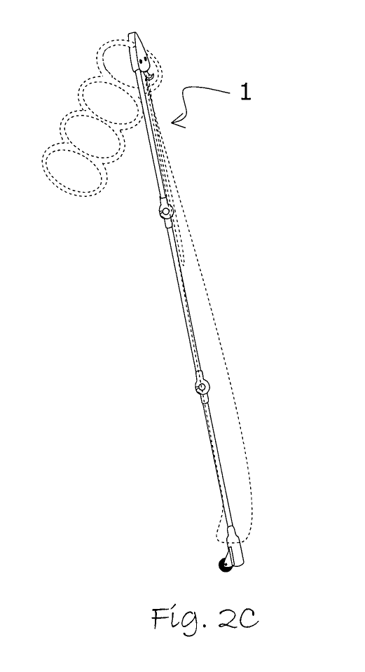

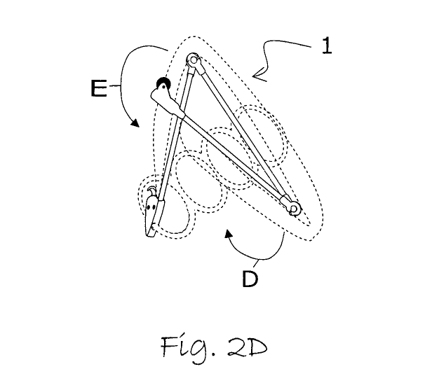

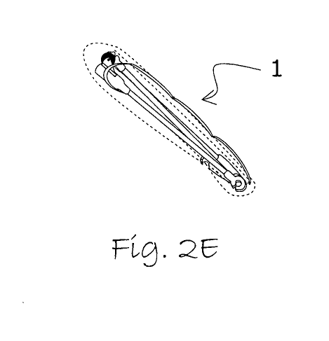

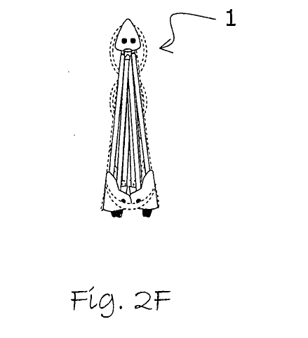

FIGS. 2A-2F illustrate exemplary steps that may be taken to collapse cart 1. First, as illustrated in FIG. 2A, locking joint 10 is released to swing base 26 of the frame up toward the center of cart 1 as indicated by arrow A. As illustrated in FIG. 2B, first and second sides 27 and 28 of the frame may then swing inward, as indicated by arrows B and C, as base 26 of the frame is completely folded upward. FIG. 2C is a side view illustrating the configuration of cart 1 after the first step of the collapsing process. Next, as illustrated in FIG. 2D, first and second side sections 7 and 15 may be rotated upward about first and second side sections 5 and 17, respectively, as indicated by arrow D. In addition, first and second side sections 3 and 19 are rotated downward about first and second side sections 5 and 17, respectively, as indicated by arrow E, until cart 1 is collapsed. FIG. 2E is a side view of cart 1 illustrating the cart in the collapsed position. Finally, FIG. 2F is a frontal view of the collapsed cart 1 illustrating handle 2 being used to restrain cart 1 in the collapsed position. In one exemplary embodiment, an end of handle 2 may be “looped” over wheel boots 8 and 14 or wheels 9 and 13.

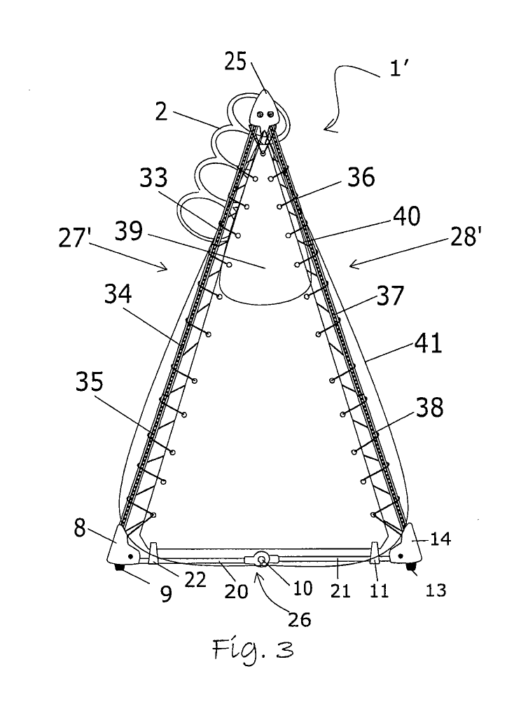

FIG. 3 is a front view of cart 1′, which is an alternative embodiment of cart 1 in accordance with the present invention, wherein similar elements are given similar reference numerals. As illustrated in FIG. 3, cart 1′ includes a telescoping triangular frame having base 26, first side 27′, and second side 28′. First side 27′ includes first side sections 33, 34, and 35, while second side 28′ includes second side sections 36, 37, and 38. The side sections of first side 27′ may be designed such that each side section slides into an adjacent side section to create a telescoping effect once locking joint 10 is released. For example, with reference to first side 27′, side section 35 may be designed to slide into side section 34, which may be designed to slide into side section 33. Alternatively, side section 33 may be designed to slide into side section 34, which may be designed to slide into side section 35. Second side 28′ may be designed in a similar manner.

As illustrated in FIG. 3, side sections 33 and 36 of first and second sides 27′ and 28′, respectively, may be attached to cap 25 with pivoting joints. Furthermore, side sections 35 and 38 may be attached to wheel boots 8 and 14, respectively, with a stationary joint. Locking joint 10 of cart 1′ along base 26 is designed to lock the frame into place and may be connected to or formed as extensions of base sections 20 and 21 as previously described above in reference to cart 1. Once again, base sections 20 and 21 may be attached to wheel boots 8 and 14, respectively, with a pivoting joint.

As illustrated in the exemplary embodiment shown in FIG. 3, back panel 39 of bag 41 may be attached to the telescoping frame via cord 40 interweaved through back panel 39 and around the frame. Back panel 39 may be anchored along base 26 of the frame with any suitable anchoring means, such as with straps or loops 11 and 22. Once again, the combination of bag 41 and back panel 39 may be manufactured as two separate components attached along the sides and bottom of the frame, or alternatively as a single, integrated unit.

As previously discussed, handle 2 may be coupled to cap 25 and may be segmented into soft, flexible sections designed to fit comfortably in the user's hand. Furthermore, handle 2 may also serve as a restraint once cart 1′ is collapsed.

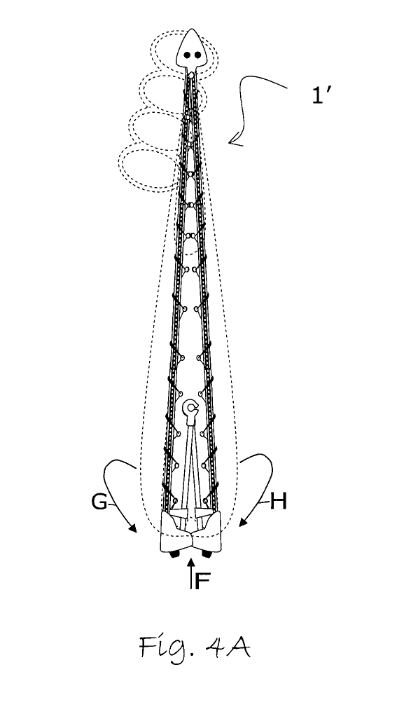

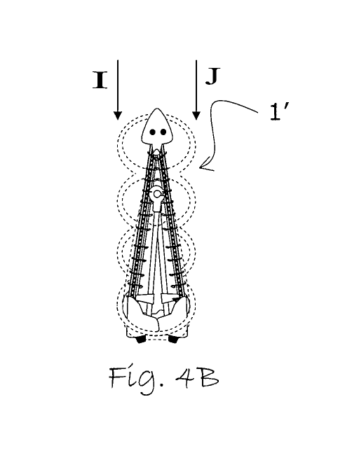

FIGS. 4A-4B illustrate exemplary steps that may be taken to collapse cart 1′. First, as illustrated in FIG. 4A, locking joint 10 may be released to swing base 26 of the frame up toward the center of cart 1′ as indicated by arrow F. First and second sides 27′ and 28′ of the frame may be structured to swing inward as base 26 of the frame is folded upward, as indicated by arrows G and H. Next, as illustrated in FIG. 4B, pressure may be applied to telescoping side sections 33, 34, and 35, as indicated by arrow 1, and to telescoping side sections 36, 37, and 38, as indicated by arrow J, until first and second sides 27′ and 28′ are collapsed. Handle 2 may then be positioned to restrain cart 1′ in the collapsed position, such as by wrapping the handle around the collapsed cart and looping the handle over the wheel boots or wheels.

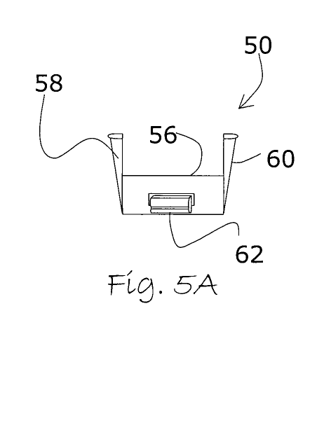

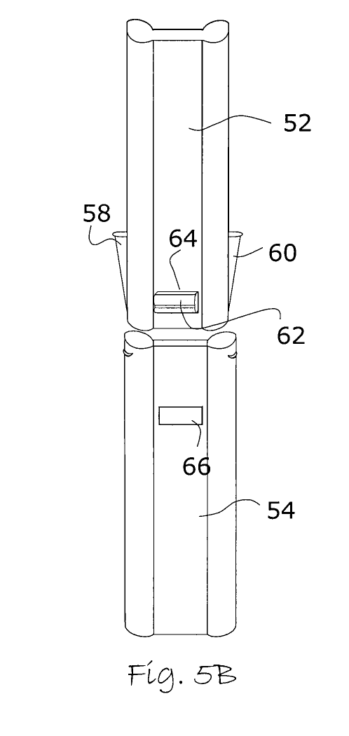

FIGS. 5A and 5B are diagrams illustrating one exemplary locking mechanism 50 for allowing a first section 52 to be telescopically received by a second section 54 that may be incorporated into cart 1′ of FIG. 3. In particular, locking mechanism 50 includes body 56, first flange portion 58, second flange portion 60, and plug member 62. Locking mechanism 50 may be formed from any suitable material, such as a plastic.

As illustrated in FIG. 5B, body 56 may be positioned within first section 52 such that first and second flange portions 58 and 60 extend from first and second flange openings (not shown), and plug member 62 extends from plug member opening 64. As will be appreciated by those skilled in the art, first section 52 may be pushed inward toward second section 54 such that the first section is received by the second section. As first section 52 is being pushed into second section 54, first and second flange portions 58 and 60 flex and are generally pushed into the corresponding first and second flange openings, while plug member 62 engages plug member opening 66 in second section 54. As a result, first section 52 is prevented from being pulled out of second section 54. However, locking mechanism 50 may act as a “soft lock,” allowing first and second sections 52 and 54 to thereafter be collapsed by application of a predetermined amount of pressure.

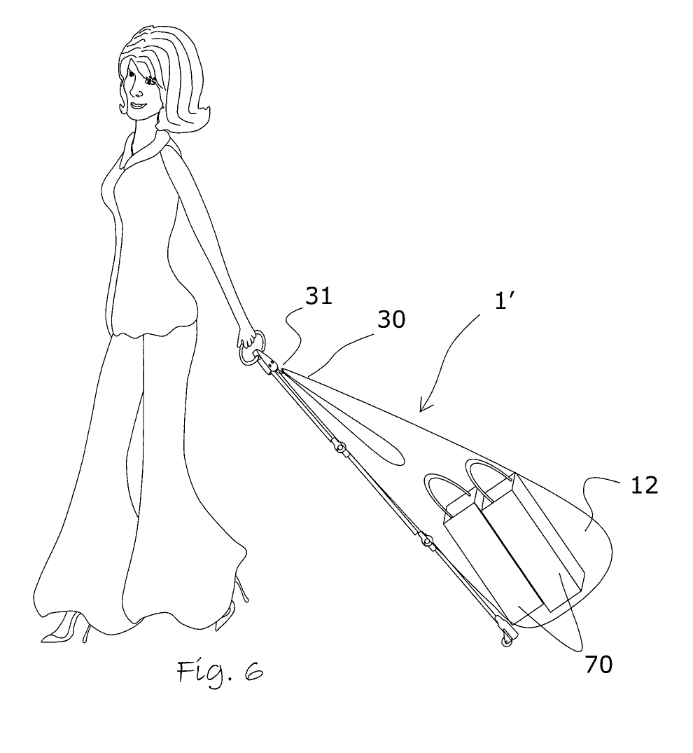

FIG. 6 is a diagram illustrating cart 1′ of FIG. 3 being pulled by a user. As illustrated in FIG. 5, the user has positioned a pair of shopping bags 70 within bag 12 of the cart. Additionally, the top of bag 12 has been closed such that top bag portion 30 is coupled to attachment means 31 as previously described. Thus, instead of having to hold one of the pair of shopping bags 50 in each hand, the user may instead position the shopping bags 70 within cart 1′, making transporting the shopping bags to the user's destination easier and more convenient.

Although the present invention has been described with reference to preferred embodiments, workers skilled in the art will recognize that changes may be made in form and detail without departing from the spirit and scope of the invention.

What is claimed is:

1. A collapsible cart comprising:
a triangular frame assembly comprising:
a base having a pair of base sections separated by a base joint, the base joint structured for allowing the base to be moved between an expanded base position and a collapsed base position;
a first side having a pair of first side sections separated by a first side joint, the first side joint structured for allowing the first side to be moved between an expanded first side position and a collapsed first side position; and
a second side having a pair of second side sections separated by a second side joint, the second side joint structured for allowing the second side to be moved between an expanded second side position and a collapsed second side position;
a pair of wheels disposed at opposing ends of the base; and
storage means coupled to the triangular frame assembly.

2. The collapsible cart of claim 1, wherein the first and second side joints are soft locking joints.

3. The collapsible cart of claim 1, wherein each of the pair of wheels is disposed within a wheel boot.

4. The collapsible cart of claim 1, wherein the storage means is attachable to the triangular frame assembly with a plurality of straps.

5. The collapsible cart of claim 1, further comprising a cap member disposed at a top of the triangular frame assembly and coupled to the first and second sides of the triangular frame assembly.

6. The collapsible cart of claim 5, further comprising a handle coupled to the cap member.

7. The collapsible cart of claim 6, wherein the handle is formed from a plurality of generally ring-shaped flexible segments.

8. The collapsible cart of claim 5, wherein the first and second sides of the triangular frame assembly are pivotally connected to the cap member such that the first and second sides may rotate relative to the cap member.

9. The collapsible cart of claim 1, further comprising a back panel coupled to the first and second sides of the triangular frame.

10. The collapsible cart of claim 9, wherein the back panel is also coupled to the base with a pair of strap members.

11. The collapsible cart of claim 1, wherein the storage means includes a top portion engageable with an attachment means on the triangular frame assembly.

12. The collapsible cart of claim 11, wherein the attachment means is a hook member.

13. The collapsible cart of claim 1, wherein the storage means is a mesh bag.

14. The collapsible cart of claim 1, wherein the base joint includes a push-button release mechanism structured to allow the base to be moved from the expanded base position to the collapsed base position when the push-button is actuated.

15. A collapsible cart comprising:
a triangular frame assembly comprising:
a base having first and second base sections separated by a base joint, the first and second base sections being rotatable about the base joint to collapse the base;
a first side having first and second side sections, the first side section of the first side being slidable within the second side section of the first side to collapse the first side; and
a second side having first and second side sections, the first side section of the second side being slidable within the second side section of the second side to collapse the second side;
a pair of wheels disposed at opposing ends of the base; and
storage means coupled to the triangular frame assembly.

16. The collapsible cart of claim 15, wherein the base joint includes a push-button release mechanism structured to allow the base to be moved from an expanded base position to a collapsed base position when the push-button is actuated.

17. The collapsible cart of claim 15, further comprising a back panel coupled to the first and second sides of the triangular frame assembly.

18. The collapsible cart of claim 17, wherein the back panel is coupled to the first and second sides of the triangular frame assembly by a cord interweaved through the back panel and around the first and second sides of the triangular frame assembly.

19. The collapsible cart of claim 15, further comprising a handle coupled to the triangular frame assembly and formed from a plurality of generally ring-shaped flexible segments.

20. A collapsible cart comprising:
a base having a pair of base sections separated by a base joint, the base joint structured for allowing the base to be moved between an expanded base position and a collapsed base position;
a first side having a pair of first side sections separated by a first collapsing means, the first collapsing means structured for allowing the first side to move between an expanded first side position and a collapsed first side position;
a second side having a pair of second side sections separated by a second collapsing means, the second collapsing means structured for allowing the second side to move between an expanded second side position and a collapsed second side position;
two or more wheels coupled to the base; and
storage means coupled to the first and second sides.
